(19) United States
(12) Patent Application Publication
(10) Pub. No.: US 2010/0077988 A1
(43) Pub. Date: Apr. 1, 2010

(54) HYDROGEN-ONLY 6-STROKE ENGINE

(75) Inventor: Tomoki YAMASAKI, Kyoto (JP)

Correspondence Address: BIRCH STEWART KOLASCH & BIRCH, PO BOX 747, FALLS CHURCH, VA, 22040-0747, US

(73) Assignee: Japan Hydrogen Co. Ltd., kyoto (JP)

(21) Appl. No.: 12/334,310

(22) Filed: Dec. 12, 2008

(30) Foreign Application Priority Data
Sep. 30, 2008 (JP) 2008-252108

(51) Int. Cl. F02B 1/14

(52) U.S. Cl. 123/27 R; 123/64; 701/102

(57) ABSTRACT

There are no prospects for engines using hydrogen as fuel to be put to practical use due to significant small output, knocking, and backfire. An object of the present invention is to obtain a stable automobile engine at high drive that can be commercially put to practical use. A hydrogen-only 6-stroke engine realizing high output by 6-strokes for premixing two to seven atmospheric pressure or high pressure hydrogen and air at equivalent weight, spraying the pre-mixture into a cylinder cooled by filling the cylinder with cold air in advance, spraying, compressing, and exploding the mixture, discharging the mixture from a lower exhaust hole, and discharging remaining waste gas from an upper exhaust hole is proposed.

### BACKGROUND OF THE INVENTION

1. Field of the Invention

The present invention relates to a reciprocal engine using hydrogen as fuel, or a hydrogen-only 6-stroke engine.

2. Description of the Related Art

There are no prospects for engines using hydrogen as fuel to be put to practical use due to significant small output, knocking, and backfire.

[Patent document 1] Japanese Laid-Open Patent Publication No. 05-240049

### SUMMARY OF THE INVENTION

There are no prospects for engines using hydrogen as fuel to be put to practical use due to significant small output, knocking, and backfire. An object of the present invention is to obtain a stable automobile engine at high drive that can be commercially put to practical use.

Firstly, in view of the lowness of the total heat quantity, which is the cause of small output of hydrogen, hydrogen and air are injected into a cylinder as equivalent weight mixed gas of two to seven atmospheric pressure, so that the generated heat quantity is equivalent to gasoline, propane, and or like.

Secondly, in view of the significant lowness in the ignition energy of the hydrogen, engine oil or emulsion is sprayed at high pressure into the cylinder and attached to an auxiliary by static electricity so that the temperature in the cylinder, in particular, the auxiliary in the cylinder is lower than or equal to the ignition temperature of hydrogen to prevent unusual ignition.

Thirdly, the combustion speed in a sealed container of hydrogen is substantially the same speed as the sound speed, and thus the shape of flame is assumed as a sphere, whereby efficient work can be exhibited in a very short period of time, the pressure on the piston is considered the best at about the radius of the bore at the very short stroke. To this end, the bore is set to the size of √2 times a conventional piston, and the number of rotations is increased when expecting the same work.

From the above three aspects, the hydrogen engine requires the 6-stroke engine shown in FIG. 1, which is operated as shown in FIG. 2. An injector spark plug, a pre-mixer of pressure gas fluid, hydrogen and air compressors commonly using the same crankshaft as the engine are required as the auxiliaries.

### BRIEF DESCRIPTION OF THE DRAWINGS

FIG. 1 shows a longitudinal cross-sectional view in which an engine and an air compression pump are operated with one crankshaft of the present invention;

FIG. 2 shows a view describing an entire system of the present invention;

FIG. 3 shows a longitudinal cross-sectional view of an injector spark plug of the present invention;

FIG. 4 shows a longitudinal cross-sectional view of a gas pre-mixer of the present invention; and

FIG. 5 shows a longitudinal cross-sectional view describing each stroke of a hydrogen-only 6-stroke engine of the present invention.

### DETAILED DESCRIPTION OF THE PREFERRED EMBODIMENTS

### [Description of Hydrogen-Only 6-Stroke Engine]

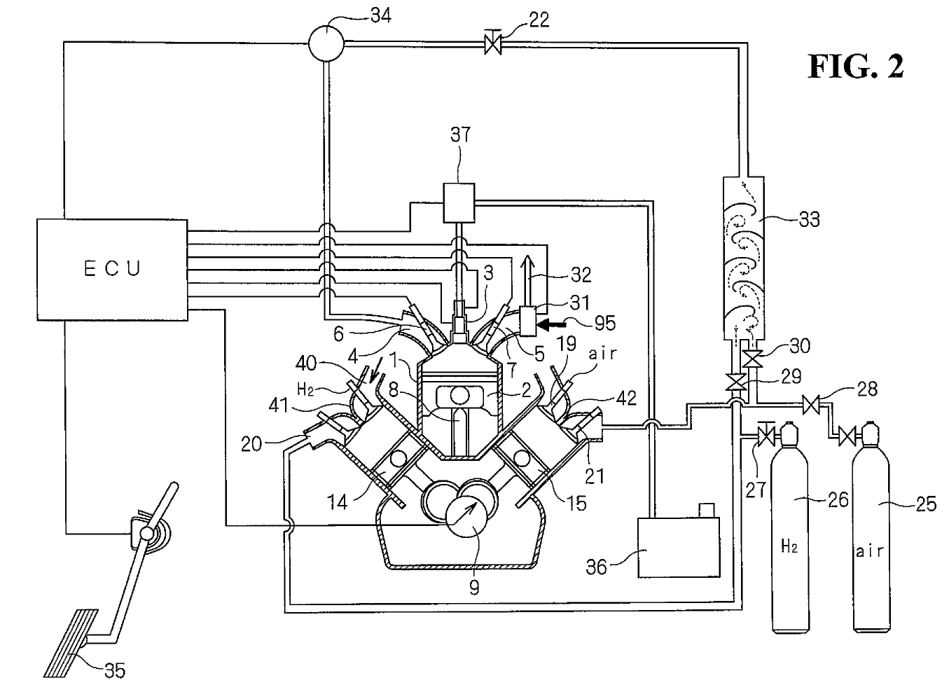

The 6-stroke engine is at the center of an engine block at the center of FIG. 2, where a piston 2 is accommodated in a cylinder 1 in a freely slidable manner, and an injector spark plug 3 is attached at a center of an upper lid.

An intake manifold 4 is attached to the left of the upper lid of the engine, and an exhaust manifold 5 is attached to the right, the manifolds being respectively arranged with a valve 6, 7. The piston 2 transmits motion to a crankshaft 9 by a con rod B. The engine requires premixed gas of high pressure air and high pressure hydrogen from the need to raise the total heat quantity to increase the output of hydrogen fuel.

A hydrogen compressor 41 is provided to compress the hydrogen to five to seven atmospheric pressure and send the hydrogen to a gas premixer 33, and is connected to the crankshaft 9 of the 6-stroke engine.

The hydrogen compressor 41 introduces hydrogen of normal pressure (one atmospheric pressure) from a hydrogen generator, not described in the present patent application, through an intake port 40, and the hydrogen is pressurized with a piston 14 coupled to the crankshaft 9, stored in a hydrogen cylinder 26 through a valve 27 from a high pressure hydrogen discharge port 20, and appropriately sent to the gas premixer 33 through valves 27, 29.

An air compressor 42 is provided to pressurize air to five to seven atmospheric pressure, where air is taken in through a valve 19 and pressurized by a piston 15 to obtain high pressure air, which is then discharged through a valve 21, stored in an air cylinder 25 through a valve 28, and sent to the gas premixer 33 through valves 28, 30 at an appropriate time during the operation of the engine.

The premixed high pressure air and high pressure hydrogen are output from the gas premixer 33 and input to a pressure adjuster 34 at where the mixed gas and the flow rate are determined by an ECU by a signal from an acceleration pedal 35, and a valve 6 is opened/closed by an instruction from the ECU so that high pressure hydrogen-air mixture is sent into a cylinder of the engine. Reference numeral 22 in FIG. 2 denotes a trap.

The injector spark plug 3 sprays oil or emulsion supplied from an oil tank 36 into the cylinder under an electrostatic atmosphere at high pressure, lowers the temperature in the cylinder to electrostatic adsorb the oil or the emulsion to the in-cylinder wall and an auxiliary, and cools and lubricates the same, where reference numeral 37 in FIG. 2 denotes a pressure adjustment valve for spraying oil or emulsion. Reference numeral 31 in the figure denotes a switching valve of an upper exhaust hole/air suction hole of the engine. Reference numeral 32 in the figure shows the flow of exhaust air from the switching valve.

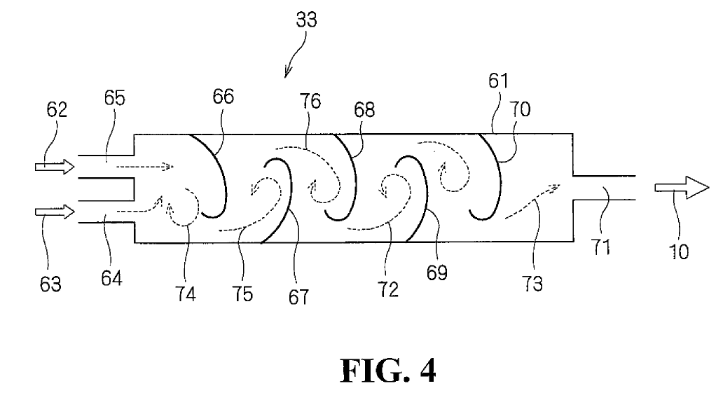

The gas premixer 33 shown in FIG. 2 is a tubular body 61 having a cylindrical or a square cylindrical shape, as shown in FIG. 4, where shield plates 66, 67, 68, 69, and 70 having the distal end bent to a fishhook shape are attached therein, few of which are alternately attached in opposite directions according to the flow rate.

When the hydrogen and the air are injected from equivalent weight inlets 65, 64 as shown by arrows 62, 63, the hydrogen and the air hit the shield plate 66 and inverted as shown by arrow 74 of a dotted line, where the hydrogen and the air are bent at the distal end of the shield plate 67 even if hitting the shield plate 67 and inverted as shown by arrow 75 so that the hydrogen and the air are gradually mixed, arrows 76, 72 repeat the mixture to obtain arrow 73, where the hydrogen and the air are completely evenly mixed when flowing out from an outlet 71 as shown by arrow 10, thereby enabling stable ignition and explosion in the engine.

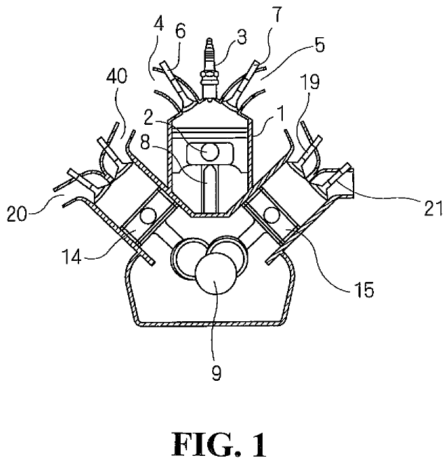

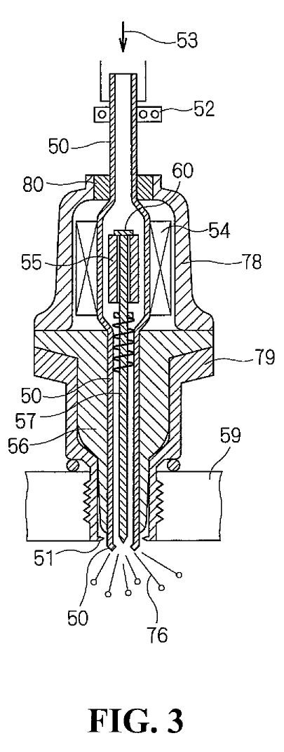

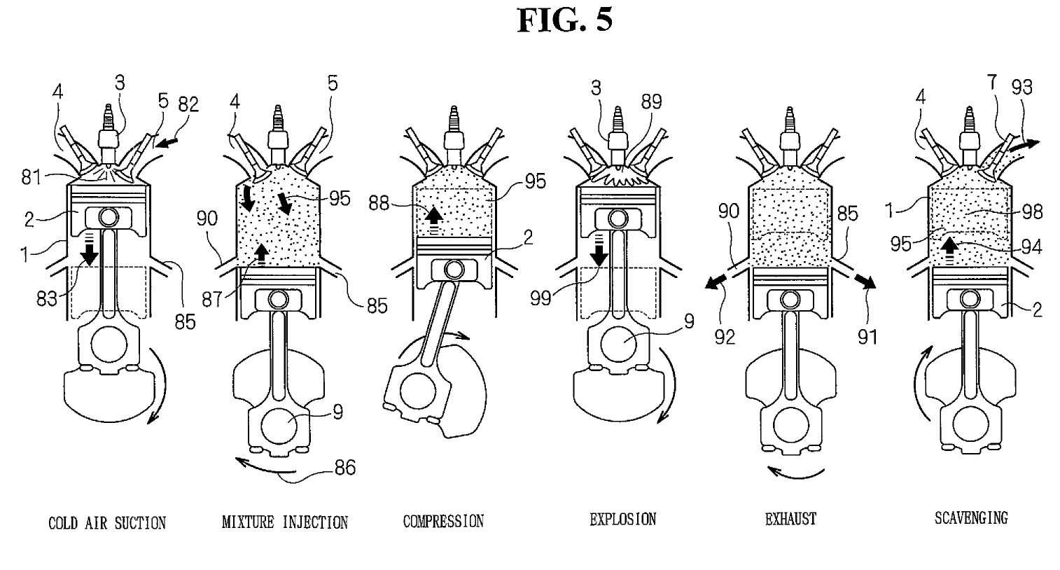

The injector spark plug 3 of FIG. 1 plays a role of spraying the emulsion into the cylinder, as shown by spray 76 of FIG. 3 and spray 81 of FIG. 5, while providing charging property of high anode, and cooling and lubricating the in-cylinder wall of the engine block and the auxiliary, and also has a role of igniting the mixed gas of hydrogen and air compressed in the cylinder by spark.

A head 59 of the engine block of FIG. 3 is attached, and the emulsion is injected at high pressure as shown by arrow 53 from the upper part of an anode tube 50. Reference numeral 52 in the figure denotes a high voltage tap serving as a power supply of the spark to spray the emulsion while providing high voltage charging property, and to ignite the mixed gas in the cylinder.

Reference numerals 78, 79 in the figure denote outer shells made of metal that surround insulative ceramics 80, 56.

A rod shaped needle 57 made of metal is arranged at the center of the anode tube 50 and has the distal end formed to a needle shape, and serves as a valve. A fixture 60 is arranged at the upper end of a magnetic needle. A tubular soft iron core 55 is arranged on the outer side of the upper part of the rod-shaped needle 57 that rises and lowers by the magnetic force of a solenoid coil 54 which traverse longitudinally in response to the instruction of the ECU according to the rod shaped needle 57, hits the fixture 60 at the upper end of the rod-shaped needle 57 to raise and lower the rod-shaped needle 57 thereby opening/closing the valve and spraying 76 the emulsion from the lower distal end.

When high voltage is applied to the high voltage tap by the instruction of the ECU, spark is generated between the distal end of the anode tube 50 and a surrounding cathode needle 51, whereby the mixed gas in the cylinder is ignited.

### [Description of In-Cylinder System of the Hydrogen-Only 6-Stroke Engine]

The present invention relates to a reciprocal engine using hydrogen as fuel.

The reciprocal engine has a significantly small output compared to carbon hydride since the total heat generation quantity of the hydrogen is low. Thus, when using hydrogen in the cylinder of the same capacity, the pressure of both the hydrogen and the air is enhanced to compensate for the degradation of the total heat generation quantity.

Since the flame transmission speed of hydrogen is close to sound speed, the output thereof is instantaneous and the explosion power needs to be changed to power in the meantime, whereby the crank of short stroke needs to be defined.

The ignition energy of hydrogen is very small compared to other gases. Furthermore, latent heat of vaporization also does not exist. That is, due to easiness in ignition, unusual ignition occurs if there is even a slight cause of ignition, which becomes the cause of knocking and backfire, and the output greatly reduces. Thus, the ignition cause requirements in the cylinder need to be managed.

Since the hydrogen does not contain lubricant substance at all, frictional wear of the in-cylinder auxiliary needs to be taken into consideration,

The present invention provides the 6-stroke engine in view of the above aspects.

The 6-cycle engine of the present invention will be described based on FIG. 5.

[First Stroke] (Cooled Suction Stroke)

In order to cool hot air in the explosion stroke described above, cold air 82 is taken in by the exhaust manifold 5, the emulsion 81 charged with positive static electricity is sprayed by the injector spark plug 3 at the upper lid, and the emulsion is adsorbed by the in-cylinder wall and the in-cylinder auxiliary charged with negative static electricity to cool the same, thereby filling the cylinder with air. The piston 2 moves downward as shown by arrow 83, and reaches the bottom dead center. The upper part of the piston 2 opens a lower exhaust hole 85, and discharges extra air for in-cylinder cooling.

[Second Stroke] (Mixture Injection Stroke)

The piston 2 reaching the bottom dead center starts to rise as shown by arrow 87 with the rotation 86 of the crankshaft 9, the hydrogen-air mixture of two to seven atmospheric pressure is taken into through the pressure adjustment valve 34 from the high-speed gas mixer 33 of FIG. 2 through the intake manifold 4 to the upper part when the lower exhaust holes 85, 90 and the exhaust manifold 5 are closed, and the cylinder is filled with pressure by the instruction of the ECU by the acceleration pedal 35.

[Third Stroke] (Compression Stroke)

Mixture 95 of cold air and hydrogen air is compressed by the piston 2 as shown by arrow 88, and gradually becomes high pressure.

[Fourth Stroke] (Explosion Stroke)

When the piston 2 reaches the vicinity of the top dead center, the voltage of the instruction from the ECU is applied to the anode tube 50 of FIG. 3 of the injector spark plug 3, and the mixture 95 is ignited by the spark with the cathode needle 51 of FIG. 3, thereby exploding and expanding 89 and strongly pushing down the piston 2 in the direction of arrow 99, and rotating the crankshaft 9 and generating power.

[Fifth Stroke] (Exhaust Stroke)

The exploded and expanded gas is discharged in the direction of arrows 91, 92 from the lower exhaust holes 85, 90 towards a sound deadening device.

[Sixth Stroke] (Scavenging Stroke)

Hot exhaust air 98 remaining in the cylinder 1 is about one tenth to fifteenth of the total emission, but still has afterheat, and thus is removed from the cylinder as shown by arrow 93 by raising the piston 2 in the direction of arrow 94 and opening the valve 7.

After clearing out the hot exhaust air, the exhaust air and the suction air are switched so that the cold air is auctioned into the cylinder 1 by the same exhaust manifold 5. The switching valve 31 of FIG. 2 performs such a role, where the arrow 93 shows the flow of the hot exhaust air, and the cold air 95 shows the flow of the suction air.

The process returns to the original first stroke after the sixth stroke, and the operation is accelerated and continued.

The present invention provides a structure of compressing both the air and the hydrogen to five to seven atmospheric pressure, premixing and injecting the mixture into the cylinder, and further compressing with the piston to thereby explode and generate power.

The present invention relates to the hydrogen-only 6-stroke engine using hydrogen as fuel to prevent global warming, but may be applied to engines using other gases as fuel.

What is claimed is:

1. A hydrogen-only 6-stroke engine realizing high output by 6-strokes for premixing two to seven atmospheric pressure or high pressure hydrogen and air at equivalent weight, spraying the pre-mixture into a cylinder cooled by filling the cylinder with cold air in advance, spraying, compressing, and exploding the mixture, discharging the mixture from a lower exhaust hole, and discharging remaining waste gas from an upper exhaust hole.

2. A hydrogen-only 6-stroke engine for spraying oil or emulsion while charging with positive static electricity at high pressure by an injector spark plug arranged at an upper lid in a cold air suction stage of a first stroke, thereby adsorbing the oil or the emulsion to an in-cylinder wall and an auxiliary at the upper lid of negative pole.

3. A hydrogen-only 6-stroke engine including an injector spark plug having a function of an injector and a spark plug through a hole at an upper lid, in which a metal rod having a needle pin at a distal end is inserted to a hollow metal tube with a spray hole at a lower end, a fixture at an end of the metal rod is hit by soft iron tube that rises and lowers the hollow metal tube and the needle pin by the magnetism of a solenoid coil to raise and lower or open and close the needle pin, oil or emulsion injected at 50 to 100 atmospheric pressure from the upper part of the metal tube is sprayed into the cylinder, high voltage of an anode is applied through the upper part of the metal tube, and spark is generated by an instruction of an ECU with a cathode at a lower part.

4. A hydrogen-only 6-stroke engine including a high-speed gas mixer in which 5 to 15 shield plates which distal end is bent to a fishhook shape are attached in a tubular body of cylindrical or square cylindrical shape, the portion bent to the fishhook shape being alternately attached in opposite directions, hydrogen and air are inverted at the fishhook portion thereby generating excess flow, excess flow being generated in the opposite direction at the next shield plate.
